(19) United States
(12) Patent Application Publication
(10) Pub. No.: US 2016/0162138 A1
(43) Pub. Date: Jun. 9, 2016

(54) ELECTRONIC DEVICE AND METHOD FOR NAVIGATING PAGES OF ELECTRONIC DEVICE

(71) Applicant: Chiun Mai Communication Systems, Inc., New Taipei (TW)

(72) Inventor: CHEN-CHAN KAO, New Taipei (TW)

(21) Appl. No.: 14/849,875

(22) Filed: Sep. 10, 2015

(30) Foreign Application Priority Data
Dec. 5, 2014 (CN) 201410731412.2

(51) Int. Cl. G06F 3/0483; G06F 3/0488

(52) U.S. Cl. CPC G06F 3/0483; G06F 3/04883

(57) ABSTRACT

In a method for searching for navigating pages of an operation object of an electronic device, a corresponding relationship between gestures of a user and page functions of the operation object is preset. When the operation object comprises more than one page, the method detects a gesture of the user on a touch screen of the electronic device. A page function of the operation object is determined according to the detected gesture and the corresponding relationship. The method calculates a destination page number of a destination page to which the operation object is to be turned according to the determined page function and a current page number of a current page of the operation object. The method further navigates the operation object to the destination page and displays the destination page of the operation object on the touch screen.

### CROSS-REFERENCE TO RELATED APPLICATIONS

This application claims priority to Chinese Patent Application No. 201410731412.2 filed on Dec. 5, 2014, the contents of which are incorporated by reference herein.

### FIELD

The subject matter herein generally relates to page navigation technology, and particularly to an electronic device and a method for navigating pages of the electronic device.

### BACKGROUND

A touch screen of an electronic device can be used as an interface with a user. Pages of a file or a webpage of the electronic device can be turned using the touch screen. For example, a page number is input on the touch screen for turning pages of the electronic device, or the file or the webpage is turned page by page according to a gesture or an input of the user on the touch screen. However, the pages of the electronic device cannot be turned in an intuitive manner, and convenience of the user in these circumstances is lost.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a block diagram of one embodiment of an electronic device including a page navigation system.

FIG. 2 illustrates a flowchart of one embodiment of a method for navigating pages of the electronic device in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure is illustrated by way of examples and not by way of limitation. It should be noted that references to “an” or “one” embodiment in this disclosure are not necessarily to the same embodiment, and such references mean “at least one.”

Furthermore, the term “module”, as used herein, refers to logic embodied in hardware or firmware, or to a collection of software instructions, written in a programming language, such as, Java, C, or assembly. One or more software instructions in the modules can be embedded in firmware, such as in an EPROM. The modules described herein can be implemented as either software and/or hardware modules and can be stored in any type of non-transitory computer-readable medium or other storage device. Some non-limiting examples of non-transitory computer-readable media include CDs, DVDs, BLU-RAY, flash memory, and hard disk drives.

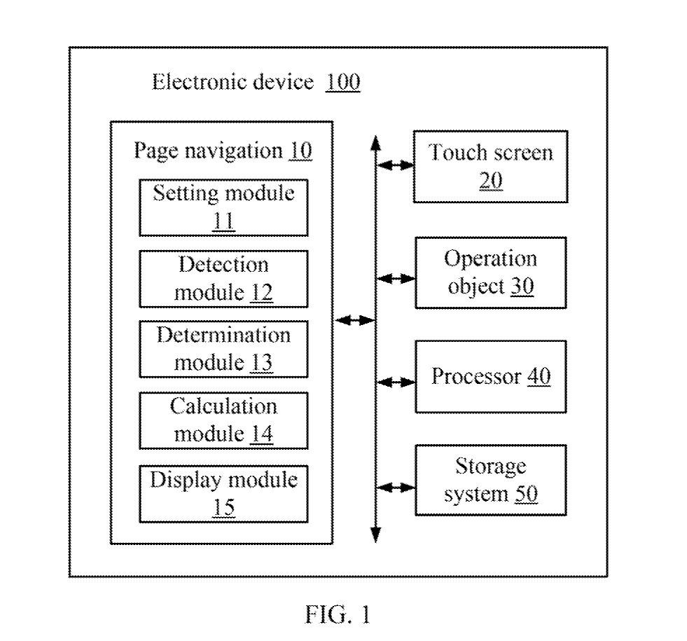

FIG. 1 illustrates a block diagram of one embodiment of an electronic device. Depending on the embodiment, an electronic device 100 includes a page navigation system 10. In one embodiment, the electronic device 100 can be a tablet computer, a notebook computer, a personal digital assistant, a mobile phone, or any other electronic device with a touch screen 20. The electronic device 100 further includes, but is not limited to, an operation object 30, at least one processor 40, and a storage system 50.

The touch screen 20 can display an operation object 30. The operation object 30 is an object to which a user can do operations. The operation object 30 can be, but is not limited to, a webpage or a file. The file may have a format including a Portable Document Format (PDF), an MS WORD document format, or a Tagged Image File Format (TIFF), or the like.

The touch screen 20 can receive and determine input by a user. In one embodiment, the nature of the input can be determined according to gestures touched on the touch screen 20 of the user. In one embodiment, the input may include characters and Arabic numerals. The characters can indicate or be associated with turning pages of the operation object 30, and can include characters to indicate page forward, page backward, and page hopping. The characters can be user-determined or pre-determined by the page navigation system 10. For example, the characters can include a letter “F” to signify page forward, a letter “B” to signify page backward, and a letter “P” to signify page hopping. The Arabic numerals can be used for indicating a number of pages of the operation object 30 to be turned. For example, the input may be F5, which requires the turning of five pages forward of the operation object 30.

In at least one embodiment, the storage system 50 can include various types of non-transitory computer-readable storage media. For example, the storage system 50 can be an internal storage system, such as a flash memory, a random access memory (RAM) for temporary storage of information, and/or a read-only memory (ROM) for permanent storage of information. The storage system 50 can also be an external storage system, such as a hard disk, a storage card, or a data storage medium. The at least one processor 40 can be a central processing unit (CPU), a microprocessor, or other data processor chip that performs functions of the electronic device 100.

In at least one embodiment, the page navigation system 10 can include a setting module 11, a detection module 12, a determination module 13, a calculation module 14, and a display module 15. The function modules 11-15 can include computerized codes in the form of one or more programs, which are stored in the storage system 50. The at least one processor 40 executes the computerized code to provide functions of the function modules 11-15.

The setting module 11 is configured to preset corresponding relationships between gestures of a user and page functions of the operation object 30. Each gesture, when input on the touch screen 20, can be recognized as generating a character and/or an Arabic numeral. The page functions indicate operations of the operation object 30 corresponding to the gestures, such as page forward, page backward, and page hopping. The setting module 11 can preset characters to be associated with the page functions of the operation object 30, for example, a letter “F” to indicate page forward, a letter “B” to indicate page backward, and a letter “P” to indicate page hopping. The setting module 11 can preset the Arabic numerals governing the number of pages in the page functions applied to the operation object 30. A gesture may include a letter and an Arabic numeral drawn on the touch screen 20. When the page function is page forward, the operation object 30 is turned forward the Arabic numeral of pages. When the page function is page backward, the operation object 30 is turned backward the Arabic numeral of pages. When the page function is page hopping, the operation object 30 is hopped to a page whose page number is equal to the Arabic numeral.

For example, a gesture of F5 corresponds to a page function of turning five pages forward of the operation object 30; a gesture of B5 corresponds to a page function of turning five pages backward of the operation object 30; and a gesture of P5 corresponds to a page function of hopping to the fifth page of the operation object 30. In another embodiment, the Arabic numeral may be replaced with a numeral in another language.

The detection module 12 is configured to detect whether the operation object 30 comprises more than one page. In the illustrated embodiment, the detection module 12 determines a largest number of pages of the operation object 30. The detection module 12 determines whether the operation object 30 is a file or a webpage. When the operation object 30 is the file, the detection module 12 determines a total number of pages of the file as the largest number of pages of the operation object 30. When the operation object 30 is the webpage, the detection module 12 obtains a largest number of pages which the webpage can have, and determines the largest number of pages which the webpage can have as the largest number of pages of the operation object 30. The largest number of pages which the webpage can have is a largest numeral corresponding to all the pages displayable by the webpage, or a largest number of pages that can be predetermined by a browser showing the webpage. When the largest number of pages of the operation object 30 is larger than one, the detection module 12 determines that the operation object 30 comprises more than one page.

The detection module 12 is further configured to detect whether page functions controlled by the gestures are activated when the operation object 30 comprises more than one page. In the embodiment, the page functions controlled by the gestures are activated by using a predetermined button. The predetermined button can be a visual button on the touch screen 20, or a physical button of the electronic device 100.

The detection module 12 is further configured to detect a gesture of the user on the touch screen 20, and determine an input according to the gesture when the page functions controlled by the gestures are activated. In the embodiment, the detection module 12 obtains input of the user on the touch screen 20, identifies characters and/or Arabic numerals from the input using character recognition technology, and determines the nature of the gesture according to the identified characters and Arabic numerals. For example, the gesture detected may be F5.

The determination module 13 is configured to determine a page function of the operation object 30 according to the detected gesture and the corresponding relationships between gestures of the user and page functions of the operation object 30. For example, when the detected gesture is F5, the determination module 13 determines that the page function of the operation object 30 is turning five pages forward of the operation object 30.

The calculation module 14 is configured to calculate a page number of a destination page to which the operation object 30 is to be turned according to the determined page function and a current page number of a current page of the operation object 30.

In the illustrated embodiment, when the determined page function is page backward, the calculation module 14 obtains a subtracted value by subtracting a predetermined value from the current page number, and determines whether the subtracted value is at least one. The detection module 12 may convert the Arabic numeral of the detected gesture to the predetermined value. When the subtracted value is at least one, the subtracted value is determined by the calculation module 14 as being valid, and the subtracted value is determined as the page number of the destination page by the calculation module 14. When the subtracted value is less than one, the calculation module 14 issues a warning that a page of the subtracted value does not exist, and determines one as the page number of the destination page.

In the illustrated embodiment, when the determined page function is page forward, the calculation module 14 obtains an added value by adding the predetermined value to the current page number, and determines whether the added value is not more than the largest number of pages of the operation object 30. When the added value is not more than the largest number of pages of the operation object 30, the calculation module 14 determines the added value as being valid, and determines the added value as the page number of the destination page. When the added value is greater than the largest number of pages of the operation object 30, the calculation module 14 issues a warning that a page of the added value does not exist, and determines the largest number of pages of the operation object 30 as the page number of the destination page.

In the illustrated embodiment, when the determined page function is page hopping, the calculation module 14 determines whether the predetermined value is in a range between number one and a number equal to the largest number of pages of the operation object 30. When the predetermined value is within such range, the calculation module 14 determines the predetermined value as being valid, and determines the predetermined value as the page number of the destination page. When the predetermined value is not within such range, the calculation module 14 issues a warning that a page for the predetermined value does not exist, and determines the current page number as the page number of the destination page.

The display module 15 is configured to navigate the operation object 30 to the destination page according to the page number of the destination page, and display the destination page of the operation object 30 on the touch screen 20.

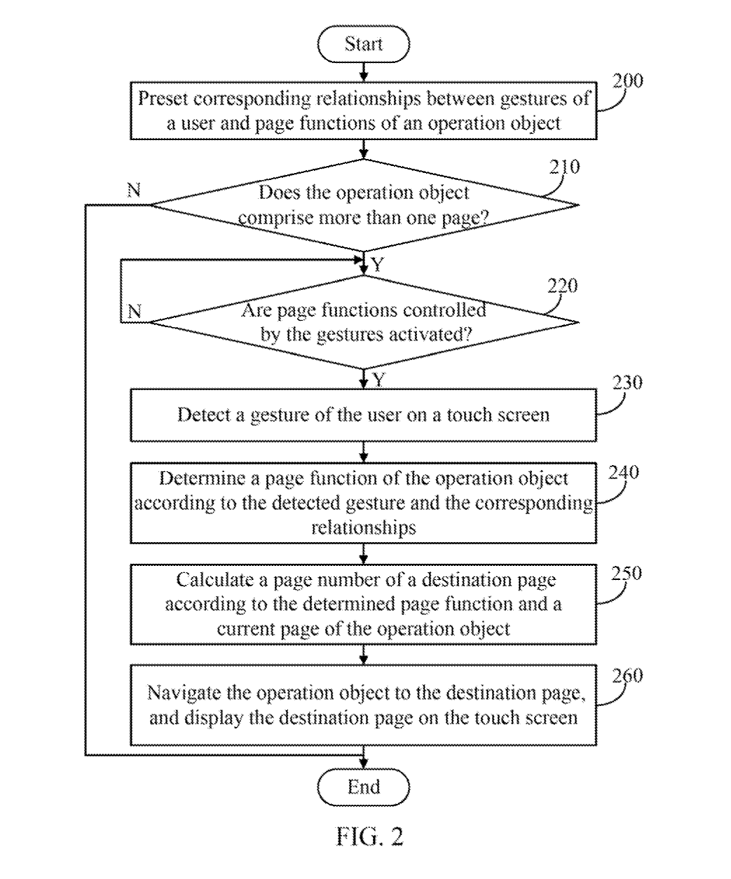

Referring to FIG. 2, a flowchart is presented in accordance with an example embodiment. The example method is provided by way of example, as there are a variety of ways to carry out the method. The method described below can be carried out using the configurations illustrated in FIG. 1, for example, and various elements of the figure are referenced in explaining example method. Each block shown in FIG. 2 represents one or more processes, methods, or subroutines, carried out in the exemplary method. Furthermore, the illustrated order of blocks is by example only and the order of the blocks can be changed. Additional blocks may be added or fewer blocks may be utilized, without departing from this disclosure. The exemplary method can begin at block 200. Depending on the embodiment, additional blocks can be added, others removed, and the ordering of the blocks can be changed.

At block 200, a setting module presets corresponding relationships between gestures of a user and page functions of an operation object of an electronic device. Each gesture, when input on a touch screen of the electronic device, can be recognized as generating a character and/or an Arabic numeral. The page functions indicate operations of the operation object corresponding to the gestures, such as page forward, page backward, and page hopping. The setting module can preset characters to be associated with the page functions of the operation object, for example, a letter “F” to indicate page forward, a letter “B” to indicate page backward, and a letter “P” to indicate page hopping. The setting module can preset the Arabic numerals governing the number of pages in the page functions applied to the operation object. A gesture may include a letter and an Arabic numeral drawn on the touch screen. When the page function is page forward, the operation object is turned forward the Arabic numeral of pages. When the page function is page backward, the operation object is turned backward the Arabic numeral of pages. When the page function is page hopping, the operation object is hopped to a page whose page number is equal to the Arabic numeral.

For example, a gesture of F5 corresponds to a page function of turning five pages forward of the operation object; a gesture of B5 corresponds to a page function of turning five pages backward of the operation object; and a gesture of P5 corresponds to a page function of hopping to the fifth page of the operation object.

At block 210, a detection module detects whether the operation object comprises more than one page. When the operation object comprises more than one page, block 220 is implemented. When the operation object does not comprise more than one page, the procedure is ended. In the embodiment, the detection module determines a largest number of pages of the operation object. The detection module determines whether the operation object is a file or a webpage. When the operation object is the file, the detection module determines a total number of pages of the file as the largest number of pages of the operation object. When the operation object is the webpage, the detection module obtains a largest number of pages which the webpage can have, and determines the largest number of pages which the webpage can have as the largest number of pages of the operation object. The largest number of pages which the webpage can have is a largest numeral corresponding to all the pages displayable by the webpage, or a largest number of pages that is predetermined by a browser showing the webpage. When the largest number of pages of the operation object is larger than one, the detection module determines that the operation object comprises more than one page.

At block 220, the detection module detects whether page functions controlled by the gestures are activated. When the page functions controlled by the gestures are activated, block 230 is implemented. When the page functions controlled by the gestures are not activated, a prompt for activating the page functions controlled by the gestures is given on the touch screen, and block 220 is repeated to continuously detect whether the page functions controlled by the gestures are activated. In the embodiment, the page functions controlled by the gestures are activated by using a predetermined button. The predetermined button can be a visual button on the touch screen, or a physical button of the electronic device.

At block 230, the detection module detects a gesture of the user on the touch screen, and determines an input according to the gesture. In the embodiment, the detection module obtains input of the user on the touch screen, identifies characters and/or Arabic numerals from the input using character recognition technology, and determines the nature of the gesture according to the identified characters and Arabic numerals.

At block 240, a determination module determines a page function of the operation object according to the detected gesture and the corresponding relationships between gestures of the user and page functions of the operation object.

At block 250, a calculation module calculates a page number of a destination page to which the operation object is to be turned according to the determined page function and a current page number of a current page of the operation object.

In the illustrated embodiment, when the determined page function is page backward, the calculation module obtains a subtracted value by subtracting a predetermined value from the current page number, and determines whether the subtracted value is at least one. A detection module may convert the Arabic numeral of the detected gesture to the predetermined value. When the subtracted value is at least one, the subtracted value is determined by the calculation module as being valid, and the subtracted value is determined as the page number of the destination page by the calculation module. When the subtracted value is less than one, the calculation module issues a warning that a page of the subtracted value does not exist, and determines one as the page number of the destination page.

In the illustrated embodiment, when the determined page function is page forward, the calculation module obtains an added value by adding the predetermined value to the current page number, and determines whether the added value is not more than the largest number of pages of the operation object. When the added value is not more than the largest number of pages of the operation object, the calculation module determines the added value as being valid, and determines the added value as the page number of the destination page. When the added value is greater than the largest number of pages of the operation object, the calculation module issues a warning that a page of the added value does not exist, and determines the largest number of pages of the operation object as the page number of the destination page.

In the illustrated embodiment, when the determined page function is page hopping, the calculation module determines whether the predetermined value is in a range between number one and a number equal to the largest number of pages of the operation object. When the predetermined value is within such range, the calculation module determines the predetermined value as being valid, and determines the predetermined value as the page number of the destination page. When the predetermined value is not within such range, the calculation module issues a warning that a page for the predetermined value does not exist, and determines the current page number as the page number of the destination page.

At block 260, a display module navigates the operation object to the destination page according to the page number of the destination page, and display the destination page of the operation object on the touch screen.

It should be emphasized that the above-described embodiments of the present disclosure, including any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included herein within the scope of this disclosure and protected by the following claims.

What is claimed is:

1. A computer-implemented method for navigating pages of an operation object of an electronic device, the method comprising:
presetting a corresponding relationship between gestures performed on a touch screen of the electronic device and page functions of the operation object;
detecting a gesture performed on the touch screen when the operation object comprises more than one page;
determining a page function of the operation object according to the detected gesture and the corresponding relationship;
calculating a destination page number of a destination page to which the operation object is to be turned according to the determined page function and a current page number of a current page of the operation object;
navigating the operation object to the destination page according to the destination page number; and
displaying the destination page of the operation object on the touch screen.

2. The method according to claim 1, wherein the detected gesture is recognized as generating a character and a numeral.

3. The method according to claim 2, wherein the determined page function is page forward, page backward, or page hopping according to the character generated by the detected gesture, the numeral generated by the detected gesture is converted to a predetermined value, and the destination page number is obtained from the predetermined value.

4. The method according to claim 3, wherein when the determined page function is page backward, the destination page number is calculated by:
obtaining a subtracted value by subtracting the predetermined value from the current page number, and determining whether the subtracted value is at least one;
determining the subtracted value as the destination page number when the subtracted value is at least one; and
determining one as the destination page number when the subtracted value is less than one.

5. The method according to claim 3, wherein when the determined page function is page forward, the destination page number is calculated by:
obtaining an added value by adding the predetermined value to the current page number, and determining whether the added value is not more than a largest number of pages of the operation object;
determining the added value as the destination page number when the added value is not more than the largest number of pages of the operation object; and
determining the largest number of pages of the operation object as the destination page number when the added value is greater than the largest number of pages of the operation object.

6. The method according to claim 3, wherein when the determined page function is page hopping, the destination page number is calculated by:
determining whether the predetermined value is in a range between number one and a number equal to a largest number of pages of the operation object;
determining the predetermined value as the destination page number when the predetermined value is within the range; and
determining the current page number as the destination page number when the predetermined value is not within the range.

7. An electronic device for navigating pages of an operation object of the electronic device, the electronic device comprising:
at least one a processor;
a touch screen; and
a storage system that stores one or more programs, when executed by the at least one processor, cause the at least one processor to perform operations comprising:
presetting a corresponding relationship between gestures performed on the touch screen and page functions of the operation object;
detecting a gesture performed on the touch screen when the operation object comprises more than one page;
determining a page function of the operation object according to the detected gesture and the corresponding relationship;
calculating a destination page number of a destination page to which the operation object is to be turned according to the determined page function and a current page number of a current page of the operation object;
navigating the operation object to the destination page according to the destination page number; and
displaying the destination page of the operation object on the touch screen.

8. The electronic device according to claim 7, wherein the detected gesture is recognized as generating a character and a numeral.

9. The electronic device according to claim 8, wherein the determined page function is page forward, page backward, or page hopping according to the character generated by the detected gesture, the numeral generated by the detected gesture is converted to a predetermined value, and the destination page number is obtained from the predetermined value.

10. The electronic device according to claim 9, wherein when the determined page function is page backward, the destination page number is calculated by:
obtaining a subtracted value by subtracting the predetermined value from the current page number, and determining whether the subtracted value is at least one;
determining the subtracted value as the destination page number when the subtracted value is at least one; and
determining one as the destination page number when the subtracted value is less than one.

11. The electronic device according to claim 9, wherein when the determined page function is page forward, the destination page number is calculated by:
obtaining an added value by adding the predetermined value to the current page number, and determining whether the added value is not more than a largest number of pages of the operation object;
determining the added value as the destination page number when the added value is not more than the largest number of pages of the operation object; and
determining the largest number of pages of the operation object as the destination page number when the added value is greater than the largest number of pages of the operation object.

12. The electronic device according to claim 9, wherein when the determined page function is page hopping, the destination page number is calculated by:
determining whether the predetermined value is in a range between number one and a number equal to a largest number of pages of the operation object;
determining the predetermined value as the destination page number when the predetermined value is within the range; and
determining the current page number as the destination page number when the predetermined value is not within the range.

13. A non-transitory storage medium having stored thereon instructions that, when executed by a processor of an electronic device, causes the processor to perform a method for navigating pages of an operation object of the electronic device, wherein the method comprises:
presetting a corresponding relationship between gestures performed on a touch screen of the electronic device and page functions of the operation object;
detecting a gesture performed on the touch screen when the operation object comprises more than one page;
determining a page function of the operation object according to the detected gesture and the corresponding relationship;
calculating a destination page number of a destination page to which the operation object is to be turned according to the determined page function and a current page number of a current page of the operation object;
navigating the operation object to the destination page according to the destination page number; and
displaying the destination page of the operation object on the touch screen.

14. The non-transitory storage medium according to claim 13, wherein the detected gesture is recognized as generating a character and a numeral.

15. The non-transitory storage medium according to claim 14, wherein the determined page function is page forward, page backward, or page hopping according to the character generated by the detected gesture, the numeral generated by the detected gesture is converted to a predetermined value, and the destination page number is obtained from the predetermined value.

16. The non-transitory storage medium according to claim 15, wherein when the determined page function is page backward, the destination page number is calculated by:
obtaining a subtracted value by subtracting the predetermined value from the current page number, and determining whether the subtracted value is at least one;
determining the subtracted value as the destination page number when the subtracted value is at least one; and
determining one as the destination page number when the subtracted value is less than one.

17. The non-transitory storage medium according to claim 15, wherein when the determined page function is page forward, the destination page number is calculated by:
obtaining an added value by adding the predetermined value to the current page number, and determining whether the added value is not more than a largest number of pages of the operation object;
determining the added value as the destination page number when the added value is not more than the largest number of pages of the operation object; and
determining the largest number of pages of the operation object as the destination page number when the added value is greater than the largest number of pages of the operation object.

18. The non-transitory storage medium according to claim 15, wherein when the determined page function is page hopping, the destination page number is calculated by:
determining whether the predetermined value is in a range between number one and a number equal to a largest number of pages of the operation object;
determining the predetermined value as the destination page number when the predetermined value is within the range; and
determining the current page number as the destination page number when the predetermined value is not within the range.
